(19) United States
(12) Patent Application Publication
(10) Pub. No.: US 2016/0321879 A1
(43) Pub. Date: Nov. 3, 2016

(54) SMOKING SIGNAL TRANSMITTING APPARATUS AND SMOKING PATTERN MANAGING APPARATUS

(71) Applicants: Taeyeon Oh, Suwon-si (KR); Junhyeong Cho, Suwon-si (KR); Hyunsoo Park, Daejeon (KR)

(72) Inventors: Taeyeon OH, Suwon-si (KR); Junhyeong Cho, Suwon-si (KR); Hyunsoo Park, Daejeon (KR); Sungjoon Lee, Pyeongtaek-si (KR)

(21) Appl. No.: 14/837,848

(22) Filed: Aug. 27, 2015

(30) Foreign Application Priority Data
Apr. 30, 2015 (KR) 10-2015-0061345

(51) Int. Cl. G08B 1/08; A24F 47/00

(52) U.S. Cl. CPC G08B 1/08; A24F 47/008

(57) ABSTRACT

A smoking signal transmitting apparatus comprises a first electric power interface electrically connected to a battery module of an e-cigarette, a controller detecting an electrical signal generated from the battery module through the first electric power interface, and a communication unit transmitting a smoking signal according to the detect result of the electrical signal, and wherein the first electric power interface is detachable from the battery module.

### CROSS-REFERENCE TO RELATED APPLICATION

This application claims the priority of the Korean Patent Application No. 10-2015-0061345, filed on Apr. 30, 2015 in the Korean Intellectual Property Office (KIPO), and all the benefits accruing therefrom under 35 U.S.C. §119, the contents of which in their entirety are herein incorporated by reference.

### BACKGROUND

The present invention relates to a smoking signal transmitting apparatus and a smoking pattern managing apparatus.

Electronic cigarettes, also known as e-cigarettes were introduced as a substitute for traditional cigarettes. The e-cigarette is an apparatus designed to vaporize a liquid solution by using the electrical energy of the battery and allows the user to inhale the vapor.

The supply of e-cigarettes is gradually increasing in the aspect that they are relatively less harmful than traditional cigarettes.

### SUMMARY

The present invention provides a smoking signal transmitting apparatus and a smoking pattern managing apparatus.

The foregoing is illustrative of technical problems of the present invention, and should not be construed as limited to technical problems set forth herein. Rather, contents described herein below shall allow those skilled in the art to fully understand other technical problems that have not been described herein.

According to one aspect of the present invention, a smoking signal transmitting apparatus comprises a first electric power interface electrically connected to a battery module of an e-cigarette, a controller detecting an electrical signal generated from the battery module through the first electric power interface, and a communication unit transmitting a smoking signal according to the detect result of the electrical signal, and wherein the first electric power interface is detachable from the battery module.

The smoking signal transmitting apparatus further comprises a second electric power interface transmitting electric power received from the battery module to an atomizer of the e-cigarette.

The second electric power interface is detachable from the atomizer.

The smoking signal transmitting apparatus further comprises a battery driving the controller and the communication unit.

The battery is charged by using electric power received through the second electric power interface.

The first electric power interface, the first electric power interface, the second electric power interface, the controller, the communication unit and the battery are comprised in a module independent of the e-cigarette.

According to another aspect of the present invention, a smoking pattern managing apparatus comprises a communication unit receiving a smoking signal, and a pattern generating unit generating smoking pattern information of the user using an e-cigarette based on the received smoking signal, wherein the smoking signal is received from a module that is detachable from the e-cigarette.

The smoking pattern information comprises at least one of smoking location information, smoking time information, and smoking amount information.

The smoking pattern managing apparatus further comprises an output unit outputs the smoking pattern information.

Specific details on other exemplary embodiments of the present invention shall be included in the description and drawings.

### BRIEF DESCRIPTION OF THE DRAWINGS

FIG. 1 is a diagram illustrating a smoking pattern management system according to an exemplary embodiment of the present invention.

FIG. 2 is a block diagram illustrating a smoking pattern management apparatus according to an exemplary embodiment of the present invention

FIG. 3 is a block diagram illustrating a smoking signal transmitting apparatus according to an exemplary embodiment of the present invention

FIG. 4 is a diagram illustrating the movement path of electric power of an e-cigarette battery according to an exemplary embodiment of the present invention

FIG. 5 is a diagram illustrating the state of an internal battery and an e-cigarette battery being charged according to an exemplary embodiment of the present invention

FIG. 6 and FIG. 7 are diagrams illustrating the exterior of a smoking signal transmitting apparatus according to an exemplary embodiment of the present invention

FIG. 8 is a diagram illustrating the state of a smoking signal transmitting apparatus installed to an e-cigarette according to an exemplary embodiment of the present invention

FIG. 9 to FIG. 11 is a diagram illustrating the state of smoking pattern information being outputted according to an exemplary embodiment of the present invention

### DETAILED DESCRIPTION

Embodiments of the present invention will be described more fully hereinafter with reference to the accompanying drawings, in which embodiments of the invention are shown. It will be understood that this inventive concept may, however, be embodied in many different forms and should not be construed as limited to the embodiments set forth herein. Rather, these embodiments are provided so that this disclosure will include all the modifications, equivalents, or substitutes within the scope of the ideology and technology of the present invention to fully convey the scope of invention to those skilled in the art. In the specification, like reference numbers refer to like elements throughout. Unless otherwise defined, all terms (including technical and scientific terms) used herein have the same meaning as commonly understood by one of ordinary skill in the art to which example embodiments belong. It will be further understood that terms, such as those defined in commonly-used dictionaries, is to be interpreted as having a meaning that is consistent with their meaning in the context of the relevant art and will not be interpreted in an idealized or overly formal sense unless expressly so defined herein.

FIG. 1 is a diagram illustrating a smoking pattern management system according to an exemplary embodiment of the present invention.

Referring to FIG. 1, a smoking pattern management system 10 comprises a smoking signal transmitting apparatus 300, a user terminal 100, and a management server 200.

The smoking signal transmitting apparatus 300 is installed to an e-cigarette and handles the function of transmitting a smoking signal. The smoking signal is a signal that is generated when the battery module equipped in the e-cigarette transmits electric power to the atomizer There is a button method and an inhale detection method to discharge electric power of a battery equipped in the battery module (hereinafter referred to as ‘e-cigarette battery’). That is, in case of the button method, when the button equipped on the e-cigarette is pressed, electric power of the e-cigarette battery becomes discharged and is transmitted to the atomizer, and in case of the inhale detection method, when the inhale by the user is detected, the e-cigarette battery becomes discharged and is transmitted to the atomizer. The smoking signal transmitting apparatus 300 is installed between the battery module and the atomizer, and when electric power of the e-cigarette battery becomes discharged and is transmitted to the atomizer, the apparatus detects this and transmits the smoking signal.

In case of the button method, ordinarily, electric power of the e-cigarette battery is not received and electric power of the e-cigarette battery is received only when the button is pressed, and the smoking signal transmitting apparatus 300 may transmit the smoking signal at this time.

Meanwhile, in case of the inhale detection method, ordinarily, electric power of the e-cigarette battery is received. Accordingly, the smoking signal transmitting apparatus may transmit the smoking signal when it detects the inhale by the user.

Herein below, the description shall be focused on the button method.

The smoking signal is transmitted to the user terminal 100, and the user terminal 100 generates smoking pattern information of the user based on the received smoking signal.

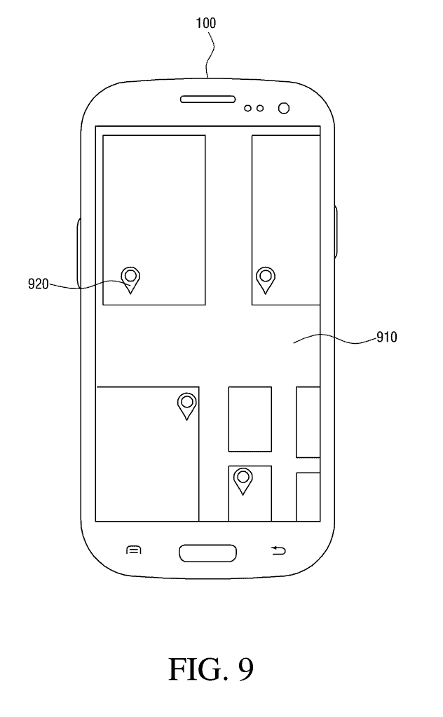

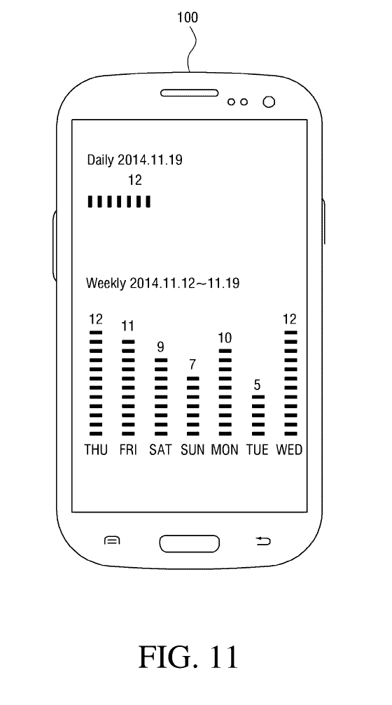

The smoking pattern information comprises smoking location information, smoking time information, smoking amount information and etc. That is, the smoking pattern information may comprise information about the location that the user smoked, the time that the user smoked and the number of times that the user smoked. The smoking pattern information will be described more fully hereinafter with reference to FIG. 9 or FIG. 11.

The user terminal 100 may output the generated smoking pattern information at least by a video or an audio. Accordingly, the user may easily check his or her smoking pattern.

The user terminal 100 may be a portable device such as a smartphone, a laptop, a netbook, a tablet PC or a smart pad, or may be a non-portable device such as a desktop.

The management server 200 may receive the smoking pattern information from the user terminal 100 and manage the information. For example, the user terminal 100 may store only short-term smoking pattern information and the management server 200 may store long-term smoking pattern information.

Furthermore, the user may connect to the management server 200 using his or her own user terminal 100 or a separate terminal and check his or her smoking pattern information.

Furthermore, the management server 200 according to another exemplary embodiment of the present invention may generate the smoking pattern information. That is, when the smoking signal transmitting apparatus 300 transmits the smoking signal to the user terminal 100, the user terminal 100 transmits an alert message to the management server 200 to notify that the smoking signal has been generated, and the management server 200 generates and updates the smoking pattern information based on the alert message.

The smoking pattern information generated by the management server 200 can be browsed by using the user terminal 100 or the separate terminal.

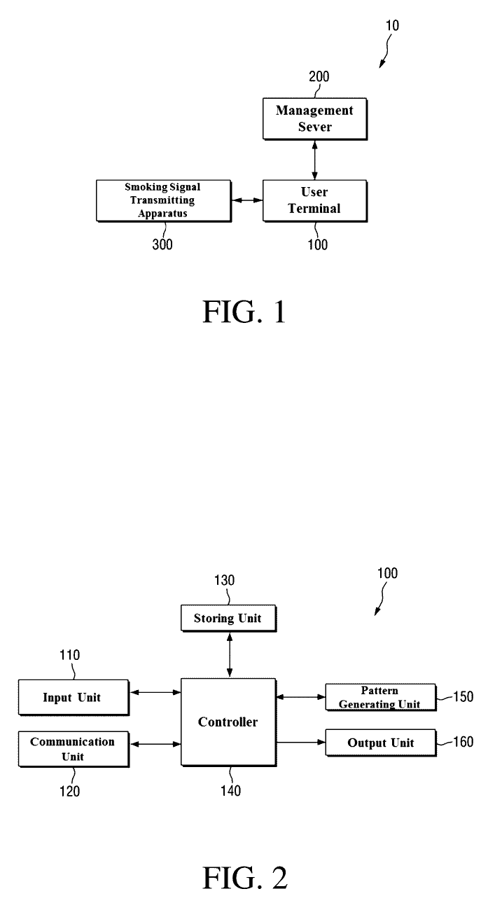

FIG. 2 is a block diagram illustrating a smoking pattern management apparatus according to an exemplary embodiment of the present invention. As aforementioned, the function of the smoking pattern management apparatus that generates the smoking pattern information can be handled by the user terminal 100 or can also be handled by the management server 200.

The status wherein the function of the smoking pattern management apparatus is handled by the user terminal 100 will be described more fully hereinafter.

Referring to FIG. 2, the smoking pattern management apparatus comprises an input unit 110, a communication unit 120, a storage unit 130, a controller 140, a pattern generating unit 150 and an output unit 160.

The input unit 110 handles the function of receiving the user command. For example, the input unit 110 may receive a command to start communication with the smoking signal transmitting apparatus 300, a command to output the smoking pattern, a command to browse smoking pattern information from the management server 200, and etc.

The communication unit 120 handles the function of receiving the smoking signal from the smoking signal transmitting apparatus 300. Since the receipt time of the smoking signal cannot be predicted, it would be more preferable for the communication unit 120 to create a session with the smoking signal transmitting apparatus 300 at all times.

The communication unit 120 may handle the wired or wireless communication with the smoking signal transmitting apparatus 300, and more preferably the unit may also handle Bluetooth communication or infrared-ray communication.

Furthermore, the communication unit 120 may connect to the management server 200, and transmit the generated smoking pattern signal to the management server 200 or receive the smoking pattern signal stored in the management server 200.

The communication unit 120 may be separately equipped with a communication means to communicate with the smoking signal transmitting apparatus 300 and a communication means to communicate with the management server 200.

The pattern generating unit 150 handles the function of generating the smoking pattern information of the user using the e-cigarette based on the received smoking signal. As aforementioned, the smoking pattern information may comprises a smoking location information, smoking time information and smoking amount information, and as such the smoking signal transmitting apparatus 300 may be equipped with a tracker (not shown), a clock (not shown), and a counter (not shown).

The storage unit 130 may handle the function of storing the smoking pattern information generated by the pattern generating unit 150. Furthermore, the storage unit 130 may store the smoking pattern information received from the management server 200.

The output unit 160 may handle the function of outputting the smoking pattern information.

The smoking pattern information may be outputted at least by a video or an audio, and to this end, the output unit 160 may include a video output module (not shown) and an audio output module (not shown).

The controller 140 may handle an overall control on the input unit 110, the communication unit 120, the storage unit 130, the pattern generating unit 150 and the output unit 160.

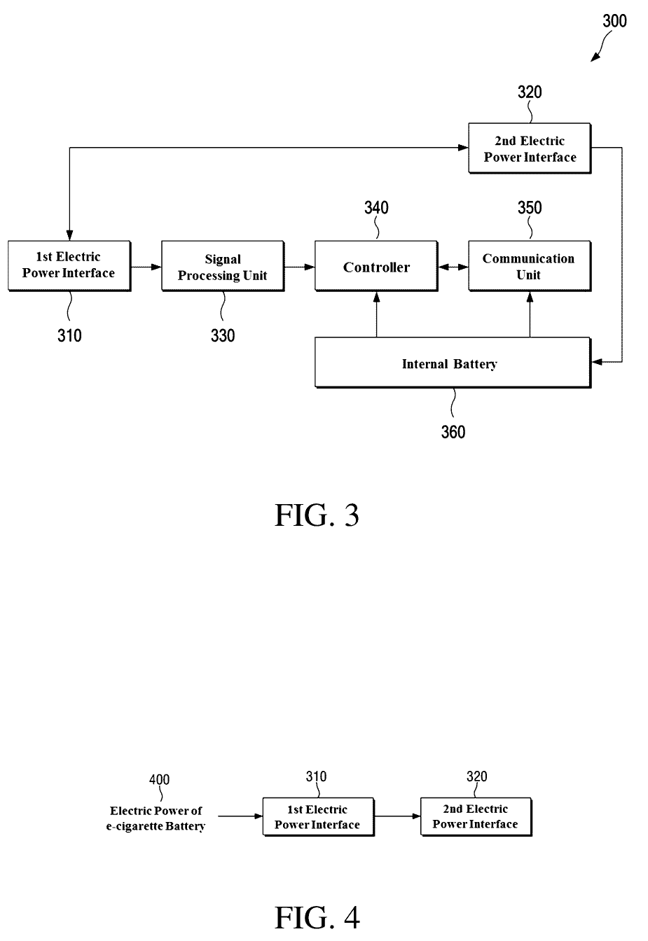

FIG. 3 is a block diagram illustrating a smoking signal transmitting apparatus according to an exemplary embodiment of the present invention.

Referring to FIG. 3, the smoking signal transmitting apparatus 300 comprises a first electric power interface 310, a second electric power interface 320, a signal processing unit 330, a controller 340, a communication unit 350 and an internal battery 360.

The first electric power interface 310 is electrically connected to the battery module of the e-cigarette and handles the function of receiving the electric power from the battery module or transmitting electric power to the battery module.

According to an exemplary embodiment of the present invention, the first electric interface 310 can be designed in a manner detachable to the battery module. That is, the user may voluntarily couple or release the first electric power interface 310 with the battery module. Furthermore, the released first electric power interface 310 may be coupled with another battery module.

The electrical signal may occur from the battery module when the e-cigarette battery discharges electric power, and this can be detected through the first electric power interface 310 by the controller 340. Herein, the electrical signal may be a pulse wave by the battery power but is not limited thereto.

The electrical signal outputted by the e-cigarette battery may be unstable and thus, it may be hard for the controller 340 to detect the signal. The signal processing unit 330 may convert the electrical signal outputted from the e-cigarette battery to the electrical signal in a relatively stable manner and transmit the signal to the controller 340. For example, the signal processing unit 330 may comprises a rectifier circuit that rectifies the pulse wave. By receiving the rectified signal, the efficiency of signal detection by the controller 340 can be enhanced. In the case that the electrical signal outputted from the e-cigarette battery is relatively stable or has a sufficient ability to analyze the signal by the controller, the signal processing unit 330 may be omitted.

When the controller 340 detects the electrical signal, the communication unit 350 may transmit the smoking signal.

The second electric power interface 320 handles the function of transmitting the electric power received from the battery module to the atomizer of the e-cigarette. Herein, the electric power of e-cigarette battery received through the first electric power interface 310 may not be consumed and transmitted as it is to the atomizer through the second electric power interface 320.

FIG. 4 is a diagram illustrating the movement path of electric power of an e-cigarette battery according to an exemplary embodiment of the present invention.

Referring to FIG. 4, when the button of the e-cigarette is pressed, the electric power of e-cigarette battery 400 becomes discharged, and the discharged power 400 is transmitted to the first electric power interface 310 that is electrically connected to the battery module.

Furthermore, the electric power transmitted to the first electric power interface 310 is entirely transmitted to the second electric power interface 320, and the electric power is transmitted to the atomizer electrically connected to the second electric power interface 320. In the end, the entire e-cigarette battery power 400 is transmitted to the atomizer.

Referring again to FIG. 3, the controller 340 and the communication unit 350 require electric power for driving which can be received through the installed internal battery 360. That is, the internal battery 360 transmits electric power to drive the controller 340 and the communication unit 350, and thus electric power received from the battery module to drive the controller 340 and the communication unit 350 need not be consumed.

Accordingly, it is possible to transmit electric power received from the battery module to the atomizer in an unconsumed state, and regardless of whether the smoking signal transmitting apparatus 300 is installed or not, the atomizer can vaporize liquid solution with sufficient electric power.

The internal battery 360 may be a primary battery, a secondary battery or a super capacitor.

In case the internal battery 360 is a secondary battery or a super capacitor, the battery may be charged by using electric power received through the second electric power interface 320. Furthermore, a part of electric power received through the second electric power interface 320 is transmitted to the battery module through the first electric power interface 310, and this may be used to charge the e-cigarette battery 840.

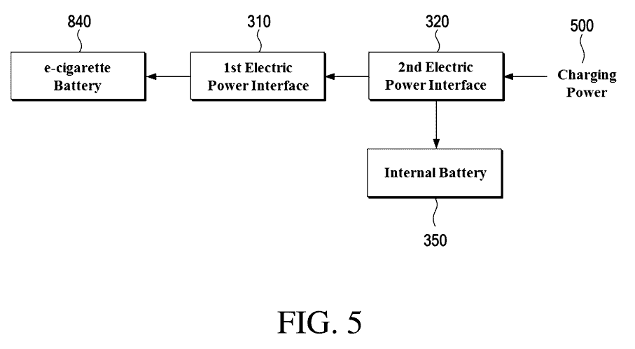

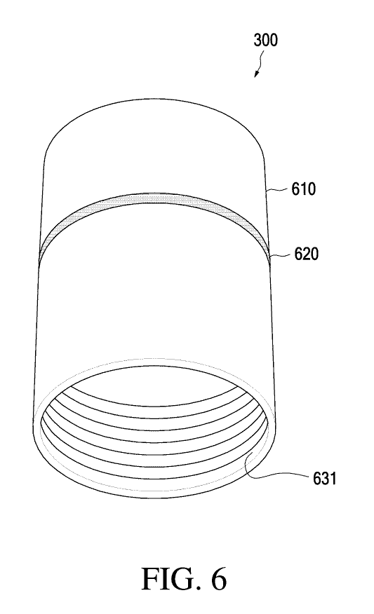

FIG. 5 is a diagram illustrating the state of an internal battery and an e-cigarette battery being charged according to an exemplary embodiment of the present invention.

In order to charge the battery, the user may remove the atomizer from the second electric power interface 320 and connect the connector of the charger adapter to the second electric power interface 320.

Accordingly, the charging power 500 transmitted from the charger adapter and etc. is received through the second electric power interface 320, and this is transmitted to the e-cigarette battery 840 through the first electric power interface 310 and the battery module. Furthermore, a part of electric power received from the second electric power interface 320 is transmitted to the internal battery 360. That is, the transmitted charging power 500 is used to charge not only the e-cigarette battery 840 but also the internal battery 360.

As such, the user may charge both the e-cigarette battery 840 and the internal battery 360 by just connecting the charger adapter to the second interface.

Referring to FIG. 3, like as the first electric power interface 310 is detachable from the battery module, the second electric power interface 320 is also detachable from the atomizer. That is, the user may voluntarily couple or release the second electric power interface 320 with the atomizer. Furthermore, the released second electric power interface 320 may be coupled again with another atomizer.

Furthermore, the first electric power interface 310, the second electric power interface 320, the controller 340, the communication unit 350 and the battery are comprised in a module independent of the e-cigarette. That is, neither the first electric power interface 310, the second electric power interface 320, the controller 340, the communication unit 350 nor the battery may be comprised in the e-cigarette and instead be comprised in the smoking signal transmitting apparatus 300, which is a separate module.

Accordingly, the smoking signal transmitting apparatus according to an exemplary embodiment of the present invention may not be only coupled with one e-cigarette but can be coupled with diverse e-cigarettes that have the same coupling method with the first electric power interface 310 and the second electric power interface 320.

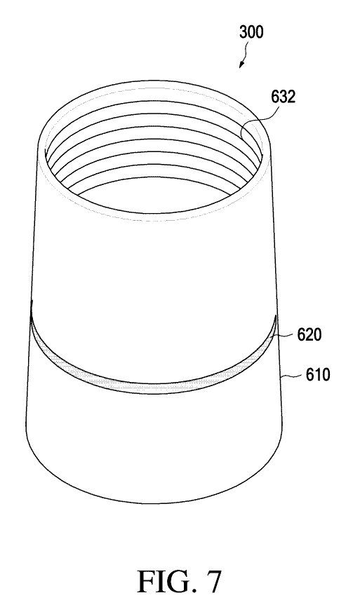

FIG. 6 and FIG. 7 are diagrams illustrating the exterior of a smoking signal transmitting apparatus according to an exemplary embodiment of the present invention.

Referring to FIG. 6 and FIG. 7, the smoking signal transmitting apparatus 300 comprises a housing 610, a motion alert unit 620, a first connection unit 631 and a second connection unit 632.

The housing 610 handles the function of receiving parts equipped in the smoking signal transmitting apparatus 300. Furthermore, the smoking signal transmitting apparatus 300 is installed between the e-cigarette battery module and the atomizer, and it is more preferable for each of the shape of both ends of the housing 610 to be similar to the shape of the e-cigarette battery module and the atomizer.

The motion alert unit 620 handles the function of notifying the motion state of the smoking signal transmitting apparatus 300 to the user. Herein, the motion state of the smoking signal transmitting apparatus 300 may comprise whether the smoking signal transmitting apparatus 300 is working normally, whether the smoking signal is being transmitted and whether the battery of the internal battery 360 is sufficient.

The motion alert module 620 may alert the user by using the light-on, light-out or the flickering of the light source such as the LED (Light Emitting Diode) or the OLED (Organic Light Emitting Diode). For example, a red light may turn on when an error occurs in the smoking signal transmitting apparatus 300, and a blue light may turn on when the smoking signal is transmitted. Furthermore, if the internal battery 360 lacks battery, a yellow light may turn on.

As such, the user may easily check the motion state of the smoking signal transmitting apparatus 300 through the color of the light source.

Furthermore, the motion alert module 620 is not shown herein, but may comprise an audio output means (not shown) or a vibration generating means (not shown) and thus enabling alert by audio or vibration.

The first connection unit 631 and the second connection unit 632 handle the function of being connected to the e-cigarette battery module and the atomizer, respectively. The battery module and the atomizer may be equipped with a screw thread for connection, and corresponding screw threads may be formed on the first connection unit 631 and the second connection unit 632.

It will be understood that a first connection unit 631 is comprised in the first electric power interface 310, and a second connection unit 632 is comprised in the second electric power interface 320. Furthermore, the first connection unit 631 and the second connection unit 632 may be electrically connected in the housing 610.

Meanwhile, FIG. 6 and FIG. 7 may illustrate screw threads formed in the first connection unit 631 and the second connection unit 632, but the shape can be modified according to the connection part of the battery module and the atomizer.

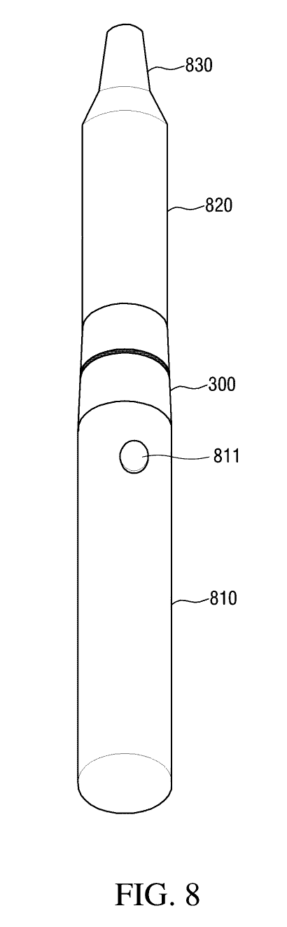

FIG. 8 is a diagram illustrating the state of a smoking signal transmitting apparatus installed to an e-cigarette according to an exemplary embodiment of the present invention.

Referring to FIG. 8, the e-cigarette comprises a battery module 810, an atomizer 820 and a drip tip 830, and the smoking signal transmitting apparatus 300 may be installed between the battery module 810 and the atomizer 820. For example, the smoking signal transmitting apparatus 300 may be coupled to the battery module 810 and to the atomizer 820 by a screw. When the user presses a button 811 installed on the battery module 810, electric power of the e-cigarette battery 840 becomes discharged and is transmitted into the smoking signal transmitting apparatus 300, and the smoking signal transmitting apparatus 300 detecting this transmits a smoking signal.

Furthermore, electric power transmitted to the smoking signal transmitting apparatus 300 is transmitted as it is to the atomizer 820 to vaporize liquid solution, and accordingly the user may inhale the vapor by using a drip tip 830.

FIG. 9 to FIG. 11 is a diagram illustrating the stated of smoking pattern information being outputted according to an exemplary embodiment of the present invention.

As aforementioned, the smoking pattern information of the present invention comprises smoking location information, smoking time information and smoking amount information. The smoking location information means a geographical location or a coordinate at which the user smoked and may include a history of locations. That is, the information may comprise multiple location information that the user has smoked for a certain period of time.

The smoking time information may comprise a history of smoking time. Furthermore, the information may comprise a history of smoking time at various time periods. For example, the smoking history of a corresponding day, week or month of the period wherein the smoking pattern information is browsed may be comprised in the smoking time information.

The smoking amount information means the degree of smoking by the user and may comprise the number of time that the user smoked and the amount of smoking. For example, the smoking information may comprise information of the number of times that the user smoked in one day, or how much of the vapor the user has inhaled. Furthermore, the information may be provided together with the smoking location information and the smoking time information.

Referring to FIG. 9, the user terminal 100 may display the smoking location 920 on an e-map 910. The smoking location may be displayed as icons and the amount of smoking may be displayed as the size of the icon. That is, if the user did not smoke much, the size of the icon will become smaller, and if the user smoked a lot, the size of the icon will become bigger.

In order to display the smoking location 920 on an e-map 910, it is more preferable for the e-map 910 to be stored in the user terminal 100 in advance and a Global Positioning System (GPS) receiver or a separate location determining means may be comprised in the user terminal 100 to determine the location.

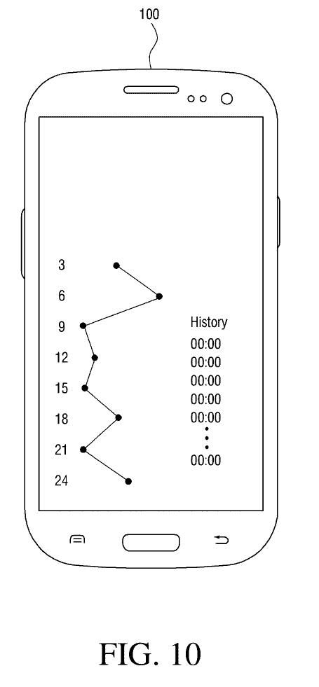

Referring to FIG. 10, the user terminal 100 may output the amount of smoking by time. It is possible for the user to check how much the user has smoked and check the amount of smoking on a corresponding time.

Referring to FIG. 11, the user terminal 100 may output the amount of smoking by day and by week. It is possible for the user to check how much the user has smoked on a corresponding date, and during the recent one week.

The foregoing has explained how information on the smoking location, the smoking time and the smoking amount can be outputted by the user terminal 100, but more diverse information may be outputted by the user terminal 100. For example, it is possible to analyze the smoking pattern up to the present point and output the estimated smoking location or the estimated smoking amount.

The foregoing description of embodiments of the present invention is intended to provide illustration and description, and those skilled in the art shall fully understand that modifications and variations are possible in light of the above teachings or may be acquired from practice of the invention. Therefore, it is to be understood that the foregoing description of embodiments is not intended to be exhaustive or to limit the invention to the precise form disclosed.

What is claimed is:

1. A smoking signal transmitting apparatus comprising:
a first electric power interface electrically connected to a battery module of an e-cigarette;
a controller detecting an electrical signal generated from the battery module through the first electric power interface; and
a communication unit transmitting a smoking signal according to the detect result of the electrical signal, and
wherein the first electric power interface is detachable from the battery module.

2. A smoking signal transmitting apparatus according to claim 1, wherein the apparatus further comprises a second electric power interface transmitting electric power received from the battery module to an atomizer of the e-cigarette.

3. A smoking signal transmitting apparatus according to claim 2, wherein the second electric power interface is detachable from the atomizer.

4. A smoking signal transmitting apparatus according to claim 2, wherein the apparatus further comprises a battery driving the controller and the communication unit.

5. A smoking signal transmitting apparatus according to claim 4, wherein the battery is charged by using electric power received through the second electric power interface.

6. A smoking signal transmitting apparatus according to claim 4, wherein the first electric power interface, the second electric power interface, the controller, the communication unit and the battery are comprised in a module independent of the e-cigarette.
